(19) United States
(12) Patent Application Publication
(10) Pub. No.: US 2016/0098645 A1
(43) Pub. Date: Apr. 7, 2016

(54) HIGH-PRECISION LIMITED SUPERVISION RELATIONSHIP EXTRACTOR

(71) Applicant: Microsoft Corporation, Redmond, WA (US)

(72) Inventors: Ashish Sharma, Bellevue, WA (US); Jianwen Zhang, Beijing (CN); Siarhei Alonichau, Bothell, WA (US); Woonyeon Yoo, Bellevue, WA (US); Yujing Wang, Beijing (CN)

(73) Assignee: Microsoft Corporation, Redmond, WA (US)

(21) Appl. No.: 14/504,507

(22) Filed: Oct. 2, 2014

(51) Int. Cl. G06N 99/00; G06N 7/00

(52) U.S. Cl. CPC G06N 99/005; G06N 7/005

(57) ABSTRACT

Automatic relationship extraction is provided. A machine learning approach using statistical entity-type prediction and relationship predication models built from large unlabeled datasets is interactively combined with minimal human intervention and a light pattern-based approach to extract relationships from unstructured, semi-structured, and structured documents. Training data is collected from a collection of unlabeled documents by matching ground truths for a known entity from existing fact databases with text in the documents describing the known entity and corresponding models are built for one or more relationship types. For a modeled relationship-type, text chunks of interest are found in a document. A machine learning classifier predicts the probability that one of the text chunks is the entity being sought. The combined machine learning and light pattern-based approach provides both improved recall and high precision through filtering and allows constraining and normalization of the extracted relationships.

### BACKGROUND

Populating fact databases describing relationships between entities and attributes of entities generally requires aggregating lots of information with a high level of precision. Manually populating large fact databases is time consuming, expensive, and, often, impracticable. Automatically populating fact databases also may be time consuming and expensive because of the difficultly in extracting data with the requisite precision from varied structured, semi-structured, and unstructured information sources using inconsistent language, units, and formats without human supervision. Conventional automatic fact extraction techniques include pattern matching and natural language processing.

Pattern matching typically uses hand-crafted and hard coded regular expressions and/or specific rules that rely on information being expressed using the same words in the same order. Without a comprehensive set of patterns, many expressions of a relationship may be missed. Adding more patterns may reduce the number of expressions missed, but may also result in capturing unrelated data. Ultimately, while careful pattern matching may improve, creating the patterns is time consuming, expensive, and non-scalable.

Natural language processing using statistical models is not limited by specific patterns, but building good models requires lots of properly annotated training data. Manually annotating large data sets to build high precision models is time consuming and expensive. Conversely, using smaller data sets or lighter supervision reduces time and cost, but also increases the likelihood of missing correct relationships or capturing incorrect relationships.

The technical problem to be solved involves automatically finding relationships in unstructured data with minimum human intervention and high precision. It is with respect to these and other considerations that the present invention has been made. Although relatively specific problems have been discussed, it should be understood that the aspects disclosed herein should not be limited to solving the specific problems identified in the background.

### BRIEF SUMMARY

This summary is provided to introduce a selection of concepts in a simplified form that are further described below in the Detailed Description section. This summary is not intended to identify key features or essential features of the claimed subject matter, nor is it intended to be used as an aid in determining the scope of the claimed subject matter.

Aspects of the relationship extractor include interactively combining a machine learning approach using statistical entity-type prediction and relationship predication models built from large unlabeled datasets with minimal human intervention and a light pattern-based approach to extract relationships from unstructured, semi-structured, and structured documents. The relationship extractor collects training data from a collection of unlabeled documents by matching ground truths for a known entity from existing fact databases with text in the documents describing the known entity and builds corresponding models for one or more relationship types. For a modeled relationship-type, the relationship extractor finds text chunks of interest in a document. A machine learning classifier predicts the probability that one of the text chunks is the entity being sought. The combined machine learning and light pattern-based approach provides both improved recall and high precision through filtering and allows constraining and normalization of the extracted relationships.

The relationship extractor includes a document parser, a natural language processor, and one or more binary classifiers. An optional page type classifier that analyzes documents and determines a page type for each document. The page type may be used to determine whether the document describes a subject that has a subject type matches a subject type compatible with the relationship type being searched.

The document parser reads the native format of a document and extracts text from the document for processing. The content of document may be structured or unstructured data. A natural language processor provides the logic for detecting mentions of an object of a selected object type that is a participant in a selected relationship type being searched for in the documents. Once mentions are detected, the natural language processor extracts features associated with the mentions. Extracted features may be compiled into a feature vector supplied as an input to the binary classifier.

For automatically training prediction models, an automatic labeler uses known facts collected from an existing fact database to label mention features as positive training examples or negative training examples and build a large set of training data. Some or all of the training data is fed into the binary classifier to build one or more prediction models, which may include relationship prediction models and entity prediction models. Predictions made using the initial prediction models are presented to a user for validation via a user interface. The user verifies whether a small number of the predictions made using the initial prediction models are correct or incorrect. Based on the inputs received from the user, the prediction models are retrained to produce the final prediction models used during runtime to process selected documents, including documents including one or more unknown relationships. The user may also specify one or more rules used to build pattern-based models to customize relationship extraction.

### BRIEF DESCRIPTION OF THE DRAWINGS

Further features, aspects, and advantages of the present disclosure will become better understood by reference to the following figures, wherein elements are not to scale so as to more clearly show the details and wherein like reference numbers indicate like elements throughout the several views:

FIG. 1 is a system diagram illustrating aspects of the relationship extractor;

FIG. 2 is a high level flowchart illustrating aspects of a method for extracting relationships from unstructured text with high precision;

FIG. 3 illustrates aspects of the views and templates generated during the data extraction operation;

FIG. 4 is a block diagram illustrating physical components of a computing device suitable for practicing aspects of the present invention;

FIG. 5A illustrates a mobile computing device suitable for practicing aspects of the present invention;

FIG. 5B is a block diagram illustrating an architecture for a mobile computing device suitable for practicing aspects of the present invention; and

FIG. 6 is a simplified block diagram of a distributed computing system with which aspects of the present invention may be practiced.

### DETAILED DESCRIPTION

Various aspects of the present invention are described more fully below with reference to the accompanying drawings, which form a part hereof, and which show specific exemplary aspects of the present invention. However, the present invention may be implemented in many different forms and should not be construed as limited to the aspects set forth herein; rather, these aspects are provided so that this disclosure will be thorough and complete, and will fully convey the scope of the various aspects to those skilled in the art. Aspects may be practiced as methods, systems, or devices. Accordingly, implementations may be practiced using hardware, software, or a combination of hardware and software. The following detailed description is, therefore, not to be taken in a limiting sense.

Aspects of the relationship extractor and accompanying method are described herein and illustrated in the accompanying figures. The relationship extractor interactively combines a machine learning approach using statistical entity-type prediction and relationship predication models built from large unlabeled datasets with minimal human intervention and a light pattern-based approach to extract relationships from unstructured, semi-structured, and structured documents. The relationship extractor collects training data from collection of unlabeled documents by matching ground truths for a known entity from existing fact databases with text in the documents describing the known entity and builds corresponding models for one or more relationship types. For a modeled relationship-type, the relationship extractor finds text chunks of interest in a document. A machine learning classifier predicts the probability that one of the text chunks is the entity being sought. The combined machine learning approach and light pattern-based approach provides both improved recall and high precision through filtering and allows constraining and normalization of the extracted relationships.

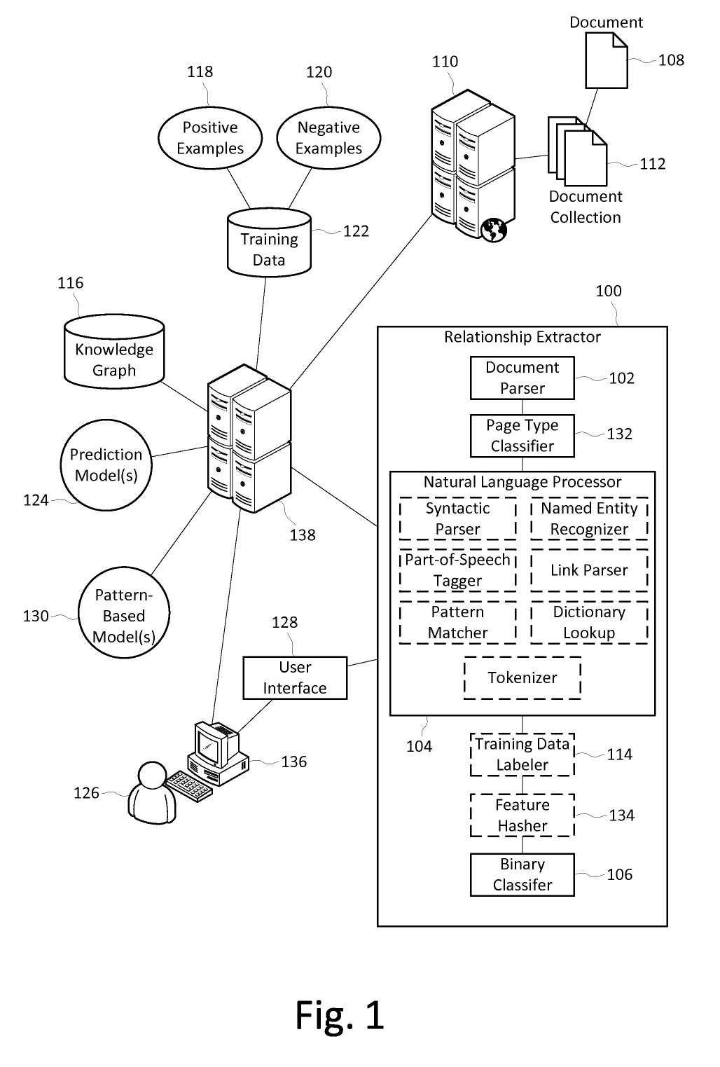

FIG. 1 is a system diagram illustrating aspects of the relationship extractor. The relationship extractor 100 includes a document parser 102, a natural language processor 104, and one or more binary classifiers 106. The document parser 102 reads the native format of a document 108 and extracts text from the document 108 for processing. The content of document may be structured or unstructured data. As used herein, unstructured data broadly encompasses free text and semi-structured text, such as information boxes, tables, and lists. The relationship extractor 100 may collect documents and store them as snapshots for processing or may collect a live document for processing.

Documents 108 may be stored in a document repository 110 as part of a document collection 112. A document is any electronic file containing relationship information in a computer readable format (i.e., computer readable text). Examples of documents include, but are not limited to, web pages, text files, and word processing files. The document may be formatted using a markup language, such as, without limitation, hypertext markup language (HTML) or extensible markup language (XML). Documents may be part of a static or dynamic collection of documents. Examples of document collections include, without limitation, online encyclopedias (e.g., Wikipedia), news sources, and article repositories. One example of a suitable document parser for HTML documents is, without limitation, the Html Agility Pack.

The natural language processor 104 provides the logic for detecting mentions of an object of a selected object type that is a participant in a selected relationship type being searched for in the documents. A relationship encompasses a subject, an object, and a predicate that semantically links the subject and the object. Relationship type refers to a description or classification of the semantic link between the subject and object. The subject may be an entity, and the object may be an entity or attribute.

An entity broadly encompasses any object or event that may be distinguished from other entities. For simplicity, an attribute refers to a value of particular property or characteristic (e.g., age or birthdate) describing an entity. Entities and attributes may be classified by corresponding types. Entity types include, without limitation, persons, organizations, locations. Attribute types include, without limitation, dates and quantities. For example, Tom Brokaw is an entity of the person entity type, NBC Nightly News is an entity of the organization entity type, New York is entity of the location entity type, and television journalist is an entity of the profession entity type. As used herein, an object type may refer to an entity type or an attribute type. A mention is a reference to a subject or object (i.e., an entity or attribute). Entities may be referenced in a text by their name, indicated by a common noun or noun phrase, or represented by a pronoun.

The natural language processor 104 may include one or more of a syntactic parser, a named entity recognizer, a part-of-speech tagger, a link parser, a pattern matcher, and a tokenizer for mention detection and feature extraction. Once mentions are detected, the natural language processor 104 extracts features associated with the mentions. Extracted features may be compiled into a feature vector supplied as an input to the binary classifier.

For automatically training prediction models, an automatic labeler 114 uses known facts (i.e., known relationships) collected from an existing knowledge graph 116, or other fact database, to label mention features as positive training examples 118 (i.e., mentions that match the object type and value of the known relationship) or negative training examples 120 (i.e., mentions that match the object type but not the value of the known relationship) to build a large set of training data 122.

Some or all of the training data is fed into the binary classifier 106 to build one or more prediction models 124, which may include relationship prediction models and entity prediction models. The prediction models 124 built using the automatically labeled training data are considered initial prediction models. Predictions made using the initial prediction models are presented to a user 126 for validation via a user interface 128. The user interface 128 allows interaction with the user 126 through a wide variety of input and output modalities. The user 126 verifies whether a small number of the predictions made using the initial prediction models are correct or incorrect. Based on the inputs received from the user 126, the prediction models are retrained to produce the final prediction models 124 used during runtime to process selected documents, including documents including one or more unknown relationships. The user may also specify one or more rules used to build pattern-based models 130 to customize relationship extraction.

The document collector may optionally include a page type classifier 132 that analyzes documents and determines a page type for each document. The page type may be used to determine whether the document describes a subject that has a subject type matches a subject type compatible with the relationship type being searched. The page type classifier may use various features of the document to determine the page type.

The document collector may optionally include a feature hasher 134 for hashing the extracted features to improve memory consumption and processing speed of the relationship extractor.

The relationship extractor 100 may be implemented in a local architecture using a single computing device or a distributed architecture using one or more computing devices, such as, without limitation, a client device 136 in communication with a server 138. The client device 136 and the server 138 may be implemented using various computing devices including, but not limited to, server or desktop computers, laptops, tablet computers, smartphones, smart watches, and smart appliances. Distributed components may be in communication via a network, such as, but not limited to, a local area network, a wide area network, or the Internet.

Two primary success measures for the relationship extractor are precision and recall. Precision is a fraction representing the number of relationships correctly identified out of the total number of relationships identified by the relationship extractor. Recall is a fraction representing the number of relationships correctly identified out of the total number of correct relationships appearing in the document. Stated differently, precision shows how many incorrect relationships were chosen (false positives), and recall shows how many correct relationships were missed (i.e., false negatives).

As used herein, high precision refers to precision of approximately 90% or greater, depending upon the intended use. The relationship extractor is capable of achieving a precision of 99% for use in populating fact databases. At the same time, the relationship extractor is capable of high recall; however, recall may be sacrificed in favor of precision.

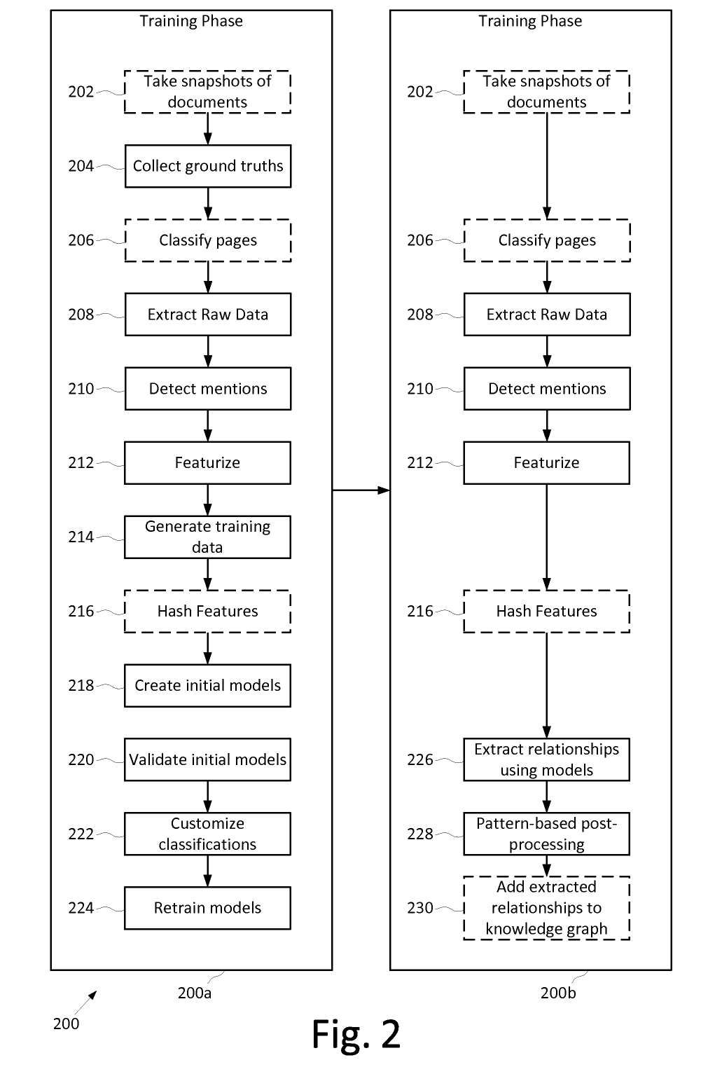

FIG. 2 is a high level flowchart illustrating aspects of a method for extracting relationships from unstructured text with high precision. The method 200 includes a training phase 200a and a runtime phase 200b.

A snapshot operation 202 obtains a snapshot of the document for analysis. The snapshot may be obtained directly from the source or reused from a previously acquired snapshot. Taking snapshots reduces repetition of data for popular entities. The snapshot operation 202 is optional as the original document may be parsed directly.

A ground truth collection operation 204 collects one or more known relationships from an existing fact database, knowledgebase, knowledge graph, or other entity-relationship database, such as Satori or Freebase. The ground truths are used as the basis of automatically annotating mentions appearing in a document when generating training data.

A page classification operation 206 determines the entity type described by the document, referred to as the page type. Page classification allows documents to be evaluated based on the relevancy of the content to the relationship type being searched. For example, if the relationship type is a birth date, there is little value in searching for dates in documents related to location entities (e.g., countries, mountains, or bridges). Evaluating only relevant documents contributes to lower resource utilization and faster search times. Moreover, evaluating only relevant pages generally improves precision because a date in a document describing the location cannot be incorrectly identified as a birth date relationship in the document if the document describing the location is not evaluated. The page classification operation 206 is optional.

Aspects of page type classification may include selecting a relevant document based on the page type and the entity or entity type of the subject participating in the relationship. During the training phase 200a, a document is selected when the entity described by the page matches the subject of the selected ground truth. During the runtime phase 200b, relevant documents may be selected when the page type matches the entity type of the subject for a relationship being searched.

A data extraction operation 208 extracts the text (i.e., content) of the document and transforms the text into one or more views (i.e., elements). For example, text may be parsed from web pages by extract the content located between the HTML <TEXT> tags. The text of the relevant documents may be parsed into one or more views including, but not limited to, sections, paragraphs, sentences, tokenized sentences, part-of-speech tags, named-entity recognition spans, hyperlink spans, section headings, and the document title. Views may be transformed into templates.

The text may be parsed and transformed to create a variety of views including, but not limited to, paragraphs, sentences, tokenized sentences, part-of-speech tags, named-entity recognition spans, hyperlink spans, and section headings. These views may be used when computing features.

A mention detection operation 210 locates mentions of the object type corresponding to the object participating in the relationship that appears in the relevant document. The object type may be a top level, or general, object type (e.g., person); however, aspects of the mention detection operation permit more specificity in the object type (e.g., female person) depending upon the techniques used to detect mentions. One technique detecting mentions is named entity recognition (NER). The object types detected using named entity recognition correspond to a limited set of generally accepted objects types, such as those recognized in the Automatic Content Extraction (ACE) Annotation Guidelines for Entities published by the Linguistic Data Consortium or by the Conference on Natural Language Learning for the Special Interest Group on Natural Language Learning of the Association for Computational Linguistics. More specifically, named entity recognition is best suited for detection of object types such as persons (PER), organizations (ORG), locations (LOC), and dates (DATE).

Mentions generally fall within one of the four mention types shown in Table 1. For comprehensive relationship extraction, detection of more types of objects is needed than is available using named entity recognition. Accordingly, the mention detection operation 210 may employ other techniques including, without limitation, dictionary lookups, entity linking, and pattern matching (e.g., using regular expressions).

TABLE 1
Mention Types

| Mention Type | Tools | Examples |
|---|---|---|
| Closed set | Dictionary | ice hockey position, |
| | | ship class |
| Half-closed set | Dictionary, | record labels |
| | Entity Linking | |
| Open set | NER, | person and film |
| | Entity Linking | names |
| Scalars | NER, Regex | date, distance, |
| | | money |

Mention detection based on entity linking uses the presence of links to other entities in the document as indicators of a mention. Where page classification is available, the entity type of the page describing the mention may be used to classify the mention type.

A dictionary stores a set of object names associated with a predicate. A dictionary facilitates detecting mentions from a closed set of values by matching a mention value with a predicate value in a dictionary. The dictionary may be created by specifying a predicate name and a unique slot type identifier and pulling known values for the predicate from a knowledge graph. The dictionary may optionally include aliases for the predicate in addition to the canonical name of the predicate.

Pattern matching facilitates detection of scalar mentions by matching a mention value with a regular expression set or based on a rule. For example, regular expressions may be used to match measurements, such as distance, in selected units.

Because ground truth values and mention values may contain insignificant or non-essential variations, the mention detection operation 210 may incorporate aspects to account for such variations, such as, without limitation, rounding, normalization, standardization, conversion, and use of tolerances. For example, when matching scalar values may have tolerances or use rounding to handle differences in precision. For matching values that may vary because of abbreviations, initials, acronyms, or the like, standardization may be used to expand abbreviations or abbreviate full words, replace words with initials, or replace names with acronyms. Where case sensitivity is not important, values may be normalized to a selected case. Where values to be matched are expressed in different units, one or both values may be converted to the same unit type. In addition, user-created custom match criteria may also be used to address variation in surface and normalized forms.

A featurization operation 212 computes features of detected mentions. Features may be computed based on the mention, a document element (e.g., sentence, paragraph, or section) containing the mention (i.e., a containing element), or a view associated with the mention. Examples of computed features include, without limitation, the location of the mention or containing element within the document, the section heading, local context features (e.g., words to the left and right of the mention, word n-grams of the containing element, left n-grams, right n-grams), the mention type, the position of the mention within the containing element, the subject of the containing element, overlap between the document title and the containing element, overlap between the document title and the first n-words of the sentence, the presence of a subject pronoun in the first n-words of the sentence, the document type, and the entity type.

An automatic training data generation operation 214 compares each mention value to the ground truth value and adds computed features to the training data used to train statistical models for entity classification and relationship classification. The training data includes a set of positive examples and negative examples. If the mention value matches the ground truth value, the computed features are added as positive examples. Conversely, if the mention value does not match the ground truth value, the computed features are added as negative examples.

A feature hashing operation 216 associates a unique identifier with each unique computed feature and provides feature compression for identical features. The unique identifier may be a hash of the feature name with a random value appended thereto. Feature hashing significantly improves memory usage and processing when dealing with large datasets such as may be generated using the relationship extractor. The feature hashing operation 216 is optional.

A sufficient number of existing fact relationships are selected and tested against corresponding documents to compute a large number of automatically labeled training data examples, both positive and negative. A large number of training data examples may be specified as a minimum number (e.g., approximately 5,000, approximately 7,500, approximately 10,000, approximately 25,000, or approximately 50,000) of total examples, positive examples, and/or negative examples. The minimum numbers for positive examples and negative examples may differ or only constrained for one type of example. For example, assume a typical document describing a person includes several date values that, when testing for a birth date relationship, produces only one positive example compared to five negative examples, on average. For a different type of relationship, the numbers of positive examples and negative examples may be more balanced. A large number of training data examples may also be specified as a minimum number of existing facts to be used in training.

A model building operation 218 feeds a portion of the training data into a binary classifier to build initial statistical models for predicting entity (i.e., page) types and relationship satisfaction. The remaining portion of the training data is reserved for testing the resulting models. Optionally, all of the training data may be used to build the entity prediction and relationship prediction models and other data used to evaluate the models. The model building operation 218 may utilize data preprocessing, such as per instance normalization and model weight regularization. Per instance normalization, such as L2 ball normalization, improves recall. Model weight regularization, such as, L2 regularization, is used to avoid over-fitting the training data. Normalization and regularization techniques other than those mentioned above may be used to improve recall and avoid over-fitting the training data. Simple linear models or models with high bias may also be used to avoid over-fitting the training data.

Once the initial statistical models are built, the model evaluation operation 220 makes corrections to the training data and adjusts a threshold for the appropriate model based on input from a user. The model evaluation operation 220 includes applying the prediction models to the test data. The prediction models compute confidence values (i.e., probabilities) that a mention satisfies the relationship based on a statistical analysis of the feature vector supplied to model. During the training phase 200a, the confidence values are used to bias the training process. During the runtime phase 200b, classifications are based on a comparison of the confidence values against a threshold, which may set to, without limitation, a default value or a value estimated from the training and/or test results.

A subset of the predictions is selected and presented to the user (e.g., a developer, annotator, or evaluator) for verification. The subset represents a small number of the number of predictions made by the relationship extractor, the number of positive examples, the number of negative examples, or the total number of training data examples. The subset may be selected as a small percentage (e.g., no more than approximately 10%, 5%, 3%, 2.5%, 2%, or 1%) of the total predictions or a fixed number (e.g., no more than approximately 500, 250, 200, 175, 150, 125, 100, 75, or 50) predictions. The predictions may be displayed via the user interface, together with the source document, for evaluation by the user. The user may respond, for example, with a yes/no answer to a confirmation question generated by relationship extractor. A confirmation question may ask the user to judge whether entity described by the document (i.e., the subject) belongs to the entity classification assigned by the relationship extractor using the initial prediction models. For example, while displaying Wikipedia page for the entity Batman, the user may be asked if the entity is properly classified as a character in a fictional universe, which is a subtype of the broader entity classification of “person.” The user's responses serve to label the evaluated predictions. The training data is updated with the user labeled predictions.

The number of items in the subset is a small number selected to provide enough information to accurately gauge the precision of the initial model. By sampling a small number of classifications per relationship type extracted, user involvement is minimized. The training model may be effectively evaluated using as few as approximately 50 predictions and rarely requires more than approximately 200 predictions to achieve the desired level of precision with the model.

A customization operation 222 may allow the user to define a pattern-based model implementing one or more patterns or rules for filtering, normalizing, and constraining the extracted relationships on the whole document. Filters or constraints may be used to limit the number of relationships that are selected from a document for a given relationship type. Without constraints or filters, all relationships where the confidence meets the threshold are selected. For some relationships, this is desirable. For example, if the subject type is congressmen and the object type is person in a membership relationship, there may be multiple persons who are members of congress mentioned in the document with a high level of confidence. However, if the object type is female person, a filter or constraint may be used to limit mentions of persons members of congress mentioned in the document with a high level of confidence.

In another example, constraints may be added that specify a person cannot play more than two sports professionally or a music band must have more than one member. Filters may dynamically specify or modify the selection threshold based on the section of the document from which the information was obtained. For example, a birth date or marriage date found in a section of document entitled “personal life” may be accepted using a lower threshold (i.e., given greater confidence) while a birth date or marriage date from a section entitled “notes” may require a higher threshold for acceptance. Similarly, by way of example, if a birth date is found in the “personal life” section, the threshold for acceptance of birth dates from other sections of the document may be raised. Normalizations may include converting values to a selected system of units or format (e.g., date or currency format) used by the target knowledge graph where extracted relationships will be stored. Such customizations generally result in increases in the recall of the relationship extractor.

A retraining operation 224 retrains the prediction models using the full set of training data updated based on the inputs from the user and adjusts the threshold in response to the inputs from the user. Estimated thresholds may be adjusted during retraining.

The method 200 allows a large set of training data to be collected and automatically annotated in a short amount of time and minimal cost. Typically, training data is collected and models with the requisite high precision and, generally, high recall, can be trained, evaluated, and customized in a few hours.

Following the training phase 200a, the method 200 may continue with the runtime phase 200b where the previously generated models are used to process documents. In contrast to the training phase, the documents processed during the runtime phase are not limited to documents describing known subjects. The documents processed by during runtime may be new documents that have not been previously processed or existing documents that are being reprocessed using new or updated models to extract new or updated relationships.

The runtime phase 200 repeats some operations from the training phase 200a, such as, the snapshot generation operation 202, the page classification operation 206, the data extraction operation 208, the mention detection operation 210, and the feature hashing operation 216. Generally, for, there is little to no difference between repeated operations in the runtime phase 200b and the training phase 200a with the exception of the documents being processed (i.e., differences in scope).

A relationship extraction operation 226 extracts relationships by applying the previously generated models previously generated in the model building operation 218 to the feature vectors produced by the runtime featurization operation 212. A post-processing operation 228 applies thresholds and the custom pattern-based model, if any, previously generated in the customization operation 222 to the documents to produce the final set of extracted relationships. A relationship storage 230 operation submits the final set of extracted relationships to a knowledge graph or other repository to improve the knowledge graph in areas such as, without limitation, the completeness, quantity, quality (i.e., accuracy), and/or recency (i.e., currentness) of the information stored in the knowledge graph.

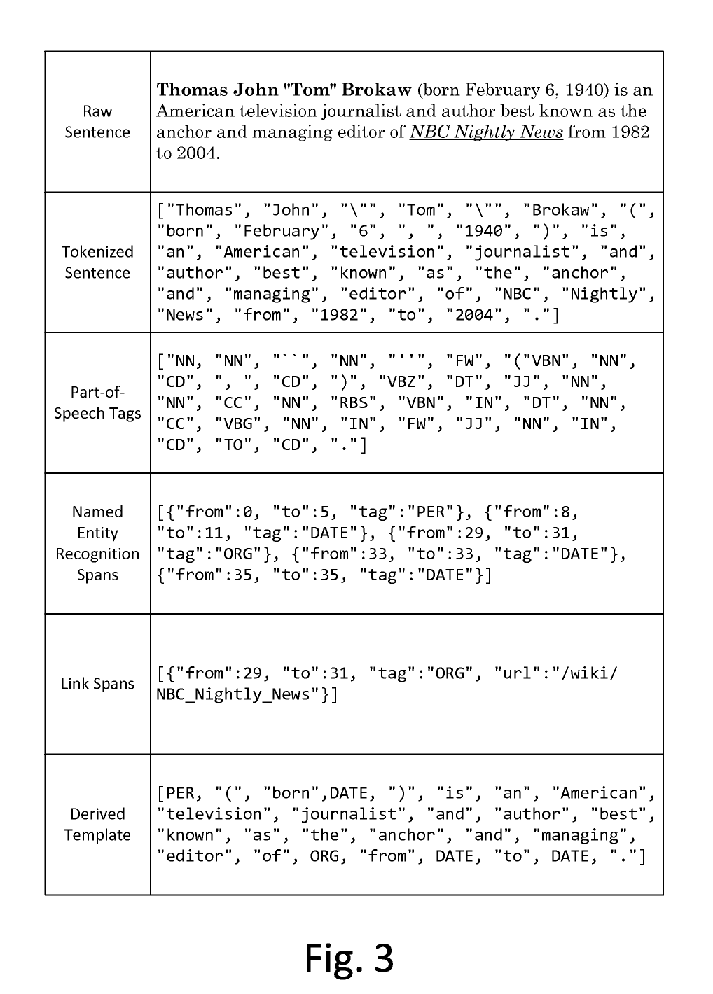

FIG. 3 illustrates aspects of the views and templates generated during the data extraction operation. The top row of the table shows a raw sentence extracted from a section of text parsed from a document.

The second row shows the tokenized sentence parsed from the raw sentence. The token delimiters are typically punctuation and space characters. Tokens are formed from each contiguous string of non-delimiter characters. Each single non-space delimiter (e.g., punctuation) character is also forms a token.

The third row shows the part-of-speech tags corresponding to tokens. The tag NN represents a singular or mass noun, FW represents a foreign word, VBN represents a past participle verb, CD represents a cardinal number, VBZ represents a third person singular present tense verb, VBG represents a gerund or past participle verb, DT represents a determiner, JJ represents an adjective, RBS represents a superlative adverb, IN represents a preposition, TO represents the infinitive “to,” and CC represents a coordinating conjunction.

The fourth row shows the named-entity recognition spans and associated entity tags. The first six tokens (“Thomas”+“John”+“\″”+“Tom”+“\″”+“Brokaw”) form one named entity span corresponding to a person. The 9^{th} through 12^{th} tokens (“February”+“6”+“1940”), the 34^{th} token (“1982”), and the 36^{th} token (“2004”) form additional named entity spans corresponding to dates (i.e., attributes). The 30^{th} through 32^{nd} tokens (“NBC”+“Nightly”+“News”) form another named entity span corresponding to an organization (i.e., an entity).

The fifth row shows the link spans, associated entity tags, and associated URLs. The 30^{th} through 32^{nd} tokens form a link span corresponding to an organization with an URL redirecting to a linked HTML document.

The sixth row shows a template generated from a transformation of the tokenized sentence using the named entity. The first six tokens are replaced with an entity tag representing a person entity object. The 9^{th} through 12^{th}, 34^{th}, and 36^{th} tokens are replaced with attribute tags representing dates. The 30^{th} through 32^{nd} tokens are replaced with an entity tag representing an organization entity object.

If this example is being matched to a fact during training of a birthdate relationship, the date objects would be candidates to participate in the birthdate relationship; however, only the date February 6, 1940 would match the known fact of the birthdate of Tom Brokaw obtained from an existing knowledge graph. Accordingly, the features constructed using the date February 6, 1940 would be added as positive training examples while features constructed from the dates 1982 and 2004 would be used as negative training examples. For example, the word bi-gram “born DATE” constructed using the derived template would be a positive training example while the word bi-grams “from DATE” and “to DATE” constructed using the derived template would be negative training examples.

Conversely, if the document describing Tom Brokaw is being analyzed to find a birthdate during runtime analysis, the statistical model would assign a high probability/confidence that the phrase “born February 6, 1940” corresponds to a date that satisfies the birthdate relationship and lower probabilities to the phrases “from 1982” and “to 2004.”

Aspects of the invention may be practiced as systems, devices, and other articles of manufacture or as methods using hardware, software, computer readable media, or combinations thereof. The following discussion and associated figures describe selected system architectures and computing devices representing the vast number of system architectures and computing devices that may be utilized for practicing aspects of the invention described herein and should not be used to limit the scope of the invention in any way.

User interfaces and information of various types may be displayed via on-board computing device displays or via remote display units associated with one or more computing devices. For example, user interfaces and information of various types may be displayed and interacted with on a wall surface onto which user interfaces and information of various types are projected. Interaction with the multitude of computing systems with which the invention may be practiced may be accomplished by, without limitation, keystroke entry, touch screen entry, voice or other audio entry, gesture entry where an associated computing device is equipped with detection (e.g., camera) functionality for capturing and interpreting user gestures for controlling the functionality of the computing device, and the like.

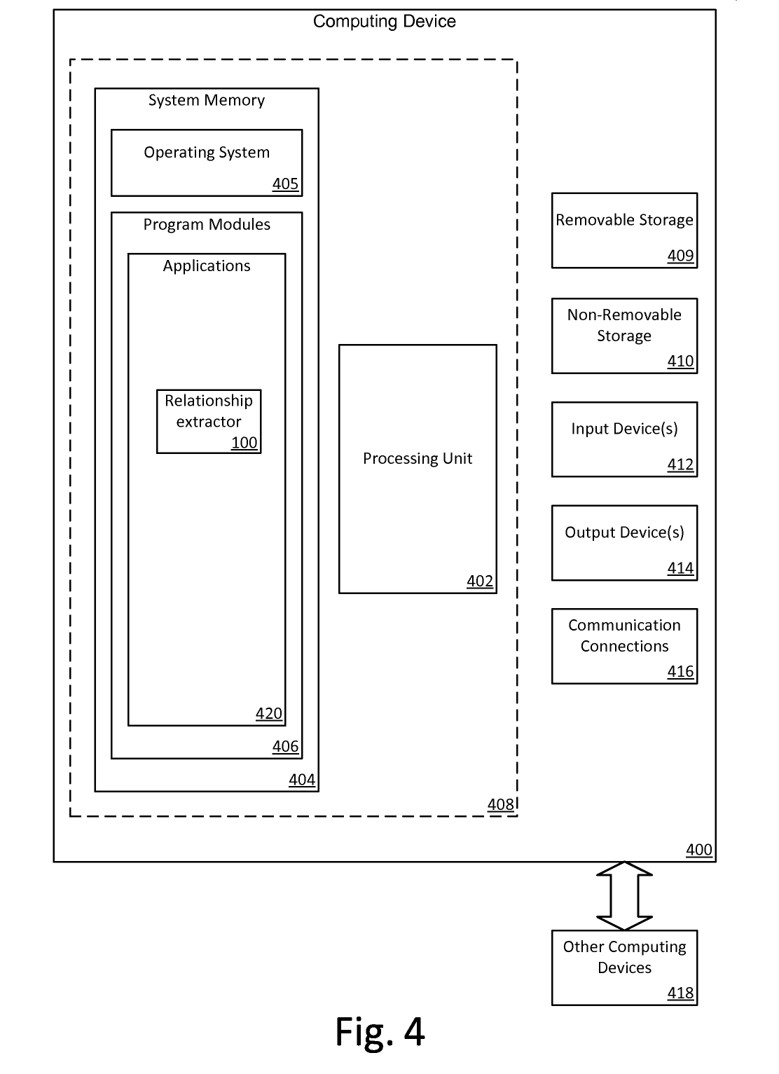

FIG. 4 is a block diagram illustrating of an architecture for a computing device with which aspects of the invention may be practiced. The computing device 400 is suitable to implement aspects of the invention embodied in a wide variety of computers and programmable consumer electronic devices including, but not limited to, mainframe computers, minicomputers, servers, personal computers (e.g., desktop and laptop computers), tablet computers, netbooks, smart phones, smartwatches, video game systems, and smart televisions, and smart consumer electronic devices.

In a basic configuration, indicated by dashed line 408, the computing device 400 may include at least one processing unit 402 and a system memory 404. Depending on the configuration and type of computing device, the system memory 404 may comprise, but is not limited to, volatile storage (e.g., random access memory), non-volatile storage (e.g., read-only memory), flash memory, or any combination of such memories. The system memory 404 may include an operating system 405 suitable for controlling the operation of the computing device 400 and one or more program modules 406 suitable for running software applications 420, including software implementing aspects of the invention described herein.

While executing on the processing unit 402, the software applications 420 may perform processes including, but not limited to, one or more of the stages of method 200. Other program modules that may be used in accordance with aspects of the invention may include electronic mail and contacts applications, word processing applications, spreadsheet applications, database applications, slide presentation applications, or computer-aided drawing application programs, etc.

In addition to the basic configuration, the computing device 400 may have additional features or functionality. For example, the computing device 400 may also include additional data storage devices (removable and/or non-removable) such as, for example, magnetic disks, optical disks, or tape. Such additional storage is illustrated by a removable storage device 409 and a non-removable storage device 410.

The computing device 400 may also have one or more input device(s) 412 such as a keyboard, a mouse, a pen, a sound input device, a touch input device, etc. The output device(s) 414 such as a display, speakers, a printer, etc. may also be included. The aforementioned devices are examples and others may be used. The computing device 400 may include one or more communication connections 416 allowing communications with other computing devices 418. Examples of suitable communication connections 416 include, but are not limited to, RF transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 404, the removable storage device 409, and the non-removable storage device 410 are all examples of computer storage media (i.e., memory storage). Computer storage media may include random access memory (RAM), read only memory (ROM), electrically erasable read-only memory (EEPROM), flash memory or other memory technology, compact disc read only memory (CD-ROM), digital versatile disks (DVD) or other optical storage, magnetic cassettes, magnetic tape, magnetic disk storage or other magnetic storage devices, or any other article of manufacture which can be used to store information and which can be accessed by the computing device 400. Any such computer storage media may be part of the computing device 400.

Aspects of the invention may be practiced in an electrical circuit comprising discrete electronic elements, packaged or integrated electronic chips containing logic gates, a circuit utilizing a microprocessor, or on a single chip containing electronic elements or microprocessors. For example, aspects of the invention may be practiced via a system-on-a-chip (SOC) where each or many of the illustrated components may be integrated onto a single integrated circuit. Such a SOC device may include one or more processing units, graphics units, communications units, system virtualization units and various application functionality all of which are integrated (or “burned”) onto the chip substrate as a single integrated circuit. When operating via a SOC, the functionality described herein with respect to the software applications 420 may be operated via application-specific logic integrated with other components of the computing device 400 on the single integrated circuit (chip). Aspects of the invention may also be practiced using other technologies capable of performing logical operations such as, for example, AND, OR, and NOT, including but not limited to mechanical, optical, fluidic, and quantum technologies. In addition, aspects of the invention may be practiced within a general purpose computer or in any other circuits or systems.

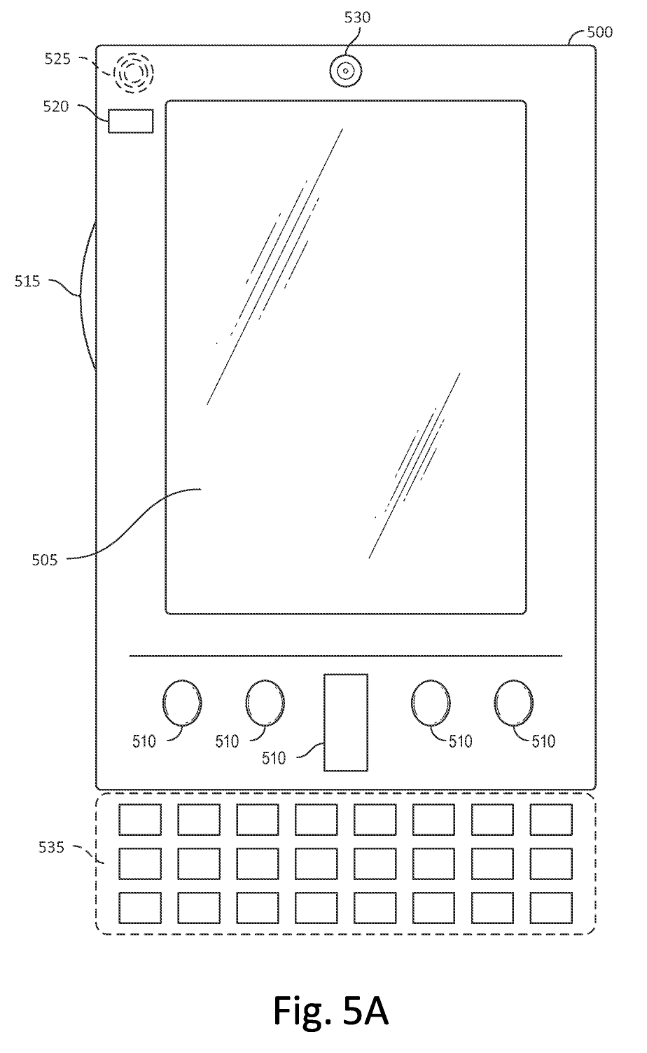

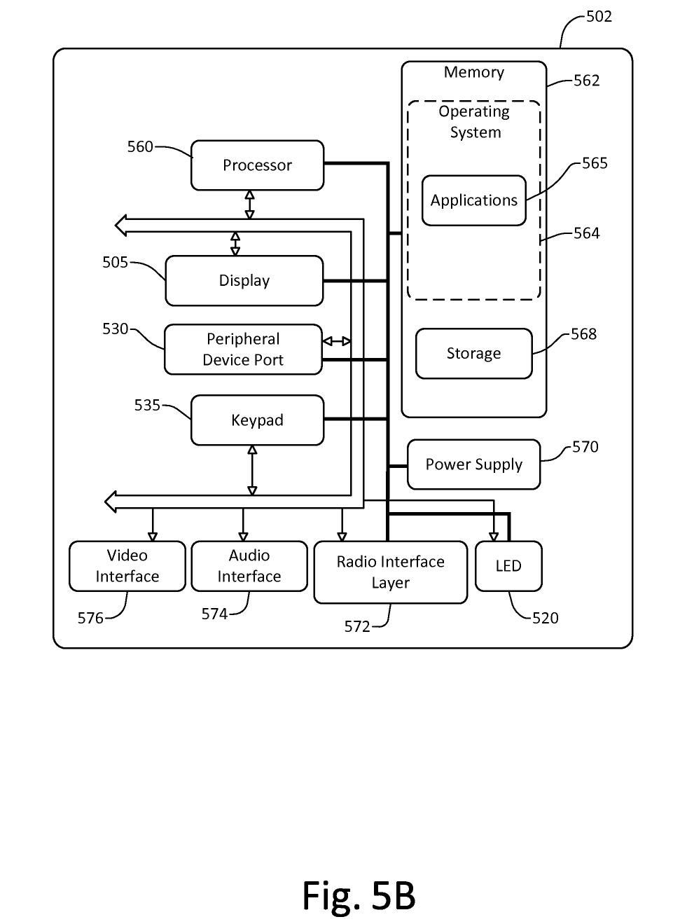

FIG. 5A illustrates a mobile computing device 500 suitable for practicing aspects of the present invention. Examples of suitable mobile computing devices include, but are not limited to, a mobile telephone, a smart phone, a tablet computer, a surface computer, and a laptop computer. In a basic configuration, the mobile computing device 500 is a handheld computer having both input elements and output elements. The mobile computing device 500 typically includes a display 505 and one or more input buttons 510 that allow the user to enter information into the mobile computing device 500. The display 505 of the mobile computing device 500 may also function as an input device (e.g., a touch screen display). If included, an optional side input element 515 allows further user input. The side input element 515 may be a rotary switch, a button, or any other type of manual input element. The mobile computing device 500 may incorporate more or fewer input elements. For example, the display 505 need not be a touch screen. The mobile computing device 500 may also include an optional keypad 535. Optional keypad 535 may be a physical keypad or a “soft” keypad generated on the touch screen display. The output elements include the display 505 for showing a graphical user interface, a visual indicator 520 (e.g., a light emitting diode), and/or an audio transducer 525 (e.g., a speaker). The mobile computing device 500 may incorporate a vibration transducer for providing the user with tactile feedback. The mobile computing device 500 may incorporate input and/or output ports, such as an audio input (e.g., a microphone jack), an audio output (e.g., a headphone jack), and a video output (e.g., a HDMI port) for sending signals to or receiving signals from an external device.

FIG. 5B is a block diagram illustrating an architecture of for a mobile computing device with which aspects of the invention may be practiced. As an example, the mobile computing device 500 may be implemented in a system 502 such as a smart phone capable of running one or more applications (e.g., browsers, e-mail clients, notes, contact managers, messaging clients, games, and media clients/players).

One or more application programs 565 may be loaded into the memory 562 and run on or in association with the operating system 564. Examples of the application programs include phone dialer programs, e-mail programs, personal information management (PIM) programs, word processing programs, spreadsheet programs, Internet browser programs, messaging programs, and so forth. The system 502 also includes a non-volatile storage area 568 within the memory 562. The non-volatile storage area 568 may be used to store persistent information that should not be lost if the system 502 is powered down. The application programs 565 may use and store information in the non-volatile storage area 568, such as e-mail or other messages used by an e-mail application, and the like. A synchronization application (not shown) also resides on the system 502 and is programmed to interact with a corresponding synchronization application resident on a host computer to keep the information stored in the non-volatile storage area 568 synchronized with corresponding information stored at the host computer. As should be appreciated, other applications may be loaded into the memory 562 and run on the mobile computing device 500, including software implementing aspects of the invention described herein.

The system 502 has a power supply 570, which may be implemented as one or more batteries. The power supply 570 might further include an external power source, such as an AC adapter or a powered docking cradle that supplements or recharges the batteries.

The system 502 may also include a radio 572 that performs the function of transmitting and receiving radio frequency communications. The radio 572 facilitates wireless connectivity between the system 502 and the outside world via a communications carrier or service provider. Transmissions to and from the radio 572 are conducted under control of the operating system 564. In other words, communications received by the radio 572 may be disseminated to the application programs 565 via the operating system 564, and vice versa.

The visual indicator 520 may be used to provide visual notifications, and/or an audio interface 574 may be used for producing audible notifications via the audio transducer 525. As shown, the visual indicator 520 may be a light emitting diode (LED). These devices may be directly coupled to the power supply 570 so that when activated, they remain on for a duration dictated by the notification mechanism even though the processor 560 and other components might shut down for conserving battery power. The LED may be programmed to remain on indefinitely until the user takes action to indicate the powered-on status of the device. The audio interface 574 is used to provide audible signals to and receive audible signals from the user. For example, in addition to being coupled to the audio transducer 525, the audio interface 574 may also be coupled to a microphone to receive audible input, such as to facilitate a telephone conversation. The microphone may also serve as an audio sensor to facilitate control of notifications, as will be described below. The system 502 may further include a video interface 576 that enables an operation of an on-board camera 530 to record still images, video stream, and the like.

A mobile computing device 500 implementing the system 502 may have additional features or functionality. For example, the mobile computing device 500 may also include additional data storage devices (removable and/or non-removable) such as, magnetic disks, optical disks, or tape. Such additional storage is illustrated by the non-volatile storage area 568. A peripheral port 540 allows external devices to be connected to the mobile computing device 500. External devices may provide additional features or functionality to the mobile computing device 500 and/or allow data to be transferred to or from the mobile computing device 500.

Data/information generated or captured by the mobile computing device 500 and stored via the system 502 may be stored locally on the mobile computing device 500, as described above, or the data may be stored on any number of storage media that may be accessed by the device via the radio 572 or via a wired connection between the mobile computing device 500 and a separate computing device associated with the mobile computing device 500, for example, a server computer in a distributed computing network, such as the Internet. As should be appreciated such data/information may be accessed via the mobile computing device 500 via the radio 572 or via a distributed computing network. Similarly, such data/information may be readily transferred between computing devices for storage and use according to well-known data/information transfer and storage means, including electronic mail and collaborative data/information sharing systems.

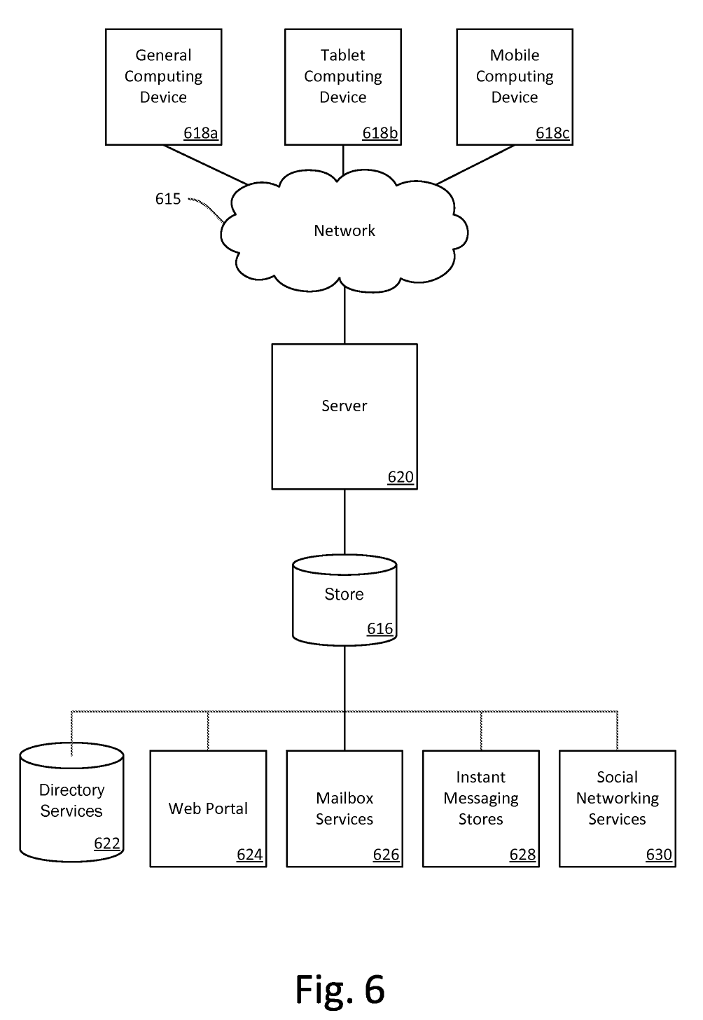

FIG. 6 is a simplified block diagram of a distributed computing system for practicing aspects of the invention. Content developed, interacted with, or edited in association with software applications, including software implementing aspects of the invention described herein, may be stored in different communication channels or other storage types. For example, various documents may be stored using a directory service 622, a web portal 624, a mailbox service 626, an instant messaging store 628, or a social networking site 630. The software applications may use any of these types of systems or the like for enabling data utilization, as described herein. A server 620 may provide the software applications to clients. As one example, the server 620 may be a web server providing the software applications over the web. The server 620 may provide the software applications over the web to clients through a network 615. By way of example, the client device may be implemented as the computing device 400 and embodied in a personal computer 618a, a tablet computer 618b, and/or a mobile computing device (e.g., a smart phone) 618c. Any of these client devices may obtain content from the store 616.

The description and illustration of one or more embodiments provided in this application are intended to provide a complete thorough and complete disclosure the full scope of the subject matter to those skilled in the art and not intended to limit or restrict the scope of the invention as claimed in any way. The aspects, embodiments, examples, and details provided in this application are considered sufficient to convey possession and enable those skilled in the art to practice the best mode of claimed invention. Descriptions of structures, resources, operations, and acts considered well-known to those skilled in the art may be brief or omitted to avoid obscuring lesser known or unique aspects of the subject matter of this application. The claimed invention should not be construed as being limited to any embodiment, example, or detail provided in this application unless expressly stated herein. Regardless of whether shown or described collectively or separately, the various features (both structural and methodological) are intended to be selectively included or omitted to produce an embodiment with a particular set of features. Further, any or all of the functions and acts shown or described may be performed in any order or concurrently. Having been provided with the description and illustration of the present application, one skilled in the art may envision variations, modifications, and alternatives falling within the spirit of the broader aspects of the general inventive concept embodied in this application that do not depart from the broader scope of the claimed invention.

What is claimed is:

1. A method for automatically extracting relationships from unstructured text, the method comprising:
selecting a relationship type describing a relationship between a subject having an entity type and an object having an object type;
locating mentions of the object type in a selected document;
for each mention located in the selected document, predicting a probability that the mention satisfies the relationship type using a statistical model built using automatically labeled training data; and
extracting one or more relationships satisfying the relationship type from the selected document.

2. The method of claim 1 further comprising the acts of:
aggregating the extracted relationships; and
applying a pattern-based model to the aggregated relationships.

3. The method of claim 1 further comprising the acts of:
computing one or more features for each mention; and
supplying the features as inputs the statistical prediction.

4. The method of claim 1 further comprising the act of determining whether each mention satisfies the relationship type based on a comparison of the probability to a threshold associated with the relationship type.

5. The method of claim 1 further comprising the act of varying the selection threshold based on a feature of the mention.

6. The method of claim 1 further comprising the act of determining whether each mention satisfies the relationship type based on a comparison of the probability to a threshold associated with the relationship type.

7. The method of claim 1 further comprising the acts of:
taking snapshots of documents from a document collection; and
selecting the document for processing from the snapshots.

8. The method of claim 1 further comprising the act of training a statistical model with a large quantity of training data automatically labeled using existing facts from a knowledge graph.

9. The method of claim 8 wherein the act of training a statistical model with a large quantity of training data automatically labeled using existing facts from a knowledge graph further comprises the act of collecting a large quantity of training data automatically labeled using existing facts from a knowledge graph.

10. The method of claim 9 wherein the act of collecting a large quantity of training data automatically labeled using existing facts from a knowledge graph further comprises the acts of:
selecting existing facts from a knowledge graph, each existing fact specifying a fact subject having an entity type, a fact object having an object type, and a fact predicate participating in a fact relationship;
locating documents describing the subject of each existing fact;
detecting mentions having an object type that matches the object type of the fact object; and
automatically labeling training data as positive or negative based on a comparison of each mention with the fact object.

11. The method of claim 10 wherein the act of automatically labeling training data as positive or negative based on a comparison of each mention with the fact object further comprises the acts of:
comparing the fact object to each mention;
using mentions that do not match the fact object to provide negative training data; and
using mentions that do match the fact object to provide positive training data.

12. The method of claim 1 wherein the act of training a statistical model with a large quantity of training data automatically labeled using existing facts from a knowledge graph further comprises the acts of:
building a statistical model using a portion of the automatically labeled training data;
generating predicted classifications by applying the statistical model to the remaining portion of the automatically labeled training data;
displaying a small number of predicted classifications for annotation by a user;
receiving annotations for the small number of predicted classifications from the user;
updating the automatically labeled training data according to the annotations received from the user; and
retraining the statistical model using the updated training data.

13. The method of claim 1 further comprising the act of tuning a selection threshold for the statistical model based on input from a user.

14. A relationship extractor implemented using a computer, the relationship extractor comprising:
a natural language processor operable to identify mentions of a subject of a selected subject type or objects of a selected object type specified in a selected relationship type appearing in a document describing the subject;
a classifier operable to predict a probability that each object identified by the natural language processor satisfies the selected relationship type with the subject using a statistical model built from a large set of automatically labeled training data; and
a post processor operable to aggregate objects associated with the selected relationship type, apply a pattern-based model to the aggregated objects, select one or more objects from the aggregated objects meeting selected criteria as a participants in relationships of the selected relationship type with the subject, and produce a final set of one or more relationships of the selected relationship type.

15. The relationship extractor of claim 14 further comprising:
a fact extractor operable to retrieve known facts for the selected relationship type from an existing knowledge graph;
the natural language processor further operable to extract training data from documents containing the known facts until a large set of training data for the selected relationship type is collected; and
a training classifier operable to build an initial model for the relationship type from at least a portion of the large set of training data.

16. The relationship extractor of claim 15 further comprising an interactive validation system operable to display a small subset of predictions made using the initial model to a user, receive input from the user indicating whether each prediction in the subset is correct or incorrect, and train a statistical model based on the input from the user.

17. The relationship extractor of claim 14 further comprising a page type classifier operable to determine a page type for a document and select the document for processing if the page type matches the subject type of the selected relationship type.

18. The relationship extractor of claim 17 wherein the page type classifier is further operable to select the document for processing if the page type matches one of the page types from a set of page types associated with the relationship type.

19. The relationship extractor of claim 14 wherein the natural language processor is further operable to extract one or more features corresponding to a mention for use in a feature vector supplied as an input to the classifier or the training classifier.

20. A computer readable medium containing computer executable instructions which, when executed by a computer, perform a method of extracting facts from free and semi-structured text using distant supervision, the method comprising:
collecting a known facts from an existing knowledge graph corresponding to a relationship type describing a relationship between a subject having an entity type and an object having an object type;
automatically labeling training data extracted from documents corresponding to the known facts;
training a statistical model with a large quantity of automatically labeled training data;
displaying a small number of classification predictions generated using the automatically labeled training data for annotation by a user;
retraining the statistical model based on the annotations received from the user;
locating mentions of the object type in a selected document;
predicting a probability that each mention satisfies the relationship type using the statistical model; and
extracting one or more relationships satisfying the relationship type from the selected document.
